(19) United States
(12) Patent Application Publication
(10) Pub. No.: US 2026/0140644 A1
(43) Pub. Date: May 21, 2026

(54) DIFFERENTIAL WORDLINE SCAN IN A MEMORY SUB-SYSTEM

(71) Applicant: Micron Technology, Inc., Boise, ID (US)

(72) Inventors: Charles See Yeung Kwong, Redwood City, CA (US); Seungjune Jeon, Santa Clara, CA (US); Jun Wan, San Jose, CA (US)

(21) Appl. No.: 18/950,828

(22) Filed: Nov. 18, 2024

(51) Int. Cl. G06F 3/06

(52) U.S. Cl. CPC G06F 3/0625; G06F 3/0653; G06F 3/0679

(57) ABSTRACT

A system includes a memory device including a plurality of memory cells; and a processing device operatively coupled with the memory device. The processing device is configured to perform operations including: receiving a read command with respect to a set of memory cells of the plurality of memory cells of the memory device; identifying a first group, of a plurality of groups, associated with the set of memory cells, wherein each of the plurality of groups comprises one or more wordlines of the memory device, and wherein each of the plurality of groups has a respective read counter and a corresponding scan-trigger criterion; incrementing a first read counter associated with the first group; determining whether a first value of the first read counter satisfies a first scan-trigger criterion associated with the first read counter; and responsive to determining that the first value satisfies the first scan-trigger criterion, performing a data integrity scan with respect to wordlines of the first group.

### TECHNICAL FIELD

Embodiments of the disclosure relate generally to memory sub-systems, and more specifically, relate to differential wordline scan in a memory sub-system.

### BACKGROUND

A memory sub-system can be a storage system, a memory module, or a hybrid of a storage device and memory module. The memory sub-system can include one or more memory components that store data. The memory components can be, for example, non-volatile memory components and volatile memory components. In general, a host system can utilize a memory sub-system to store data at the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1A illustrates an example computing environment that includes a memory sub-system in accordance with some embodiments of the present disclosure.

FIG. 1B is a block diagram of a memory device in communication with a memory sub-system controller of a memory sub-system, in accordance with some embodiments of the present disclosure.

FIG. 2 is a flow diagram of an example method of configuring a read counter for single page read disturb (SPRD) groups in a memory device in accordance with some embodiments of the present disclosure.

FIG. 3 is an example read counter data structure used for SPRD groups in a memory device in accordance with some embodiments of the present disclosure.

FIG. 4 is a flow diagram of an example method of configuring a read counter for every page read disturb (EPRD) groups in a memory device in accordance with some embodiments of the present disclosure.

FIG. 5 is an example read counter data structure used for EPRD groups in a memory device in accordance with some embodiments of the present disclosure.

FIG. 6 is a flow diagram of an example method of managing read counters for a memory device in accordance with some embodiments of the present disclosure.

FIG. 7 is a block diagram of another example method of managing read counters for a memory device in accordance with some embodiments of the present disclosure.

FIG. 8 is a block diagram of an example computer system in which embodiments of the present disclosure can operate.

### DETAILED DESCRIPTION

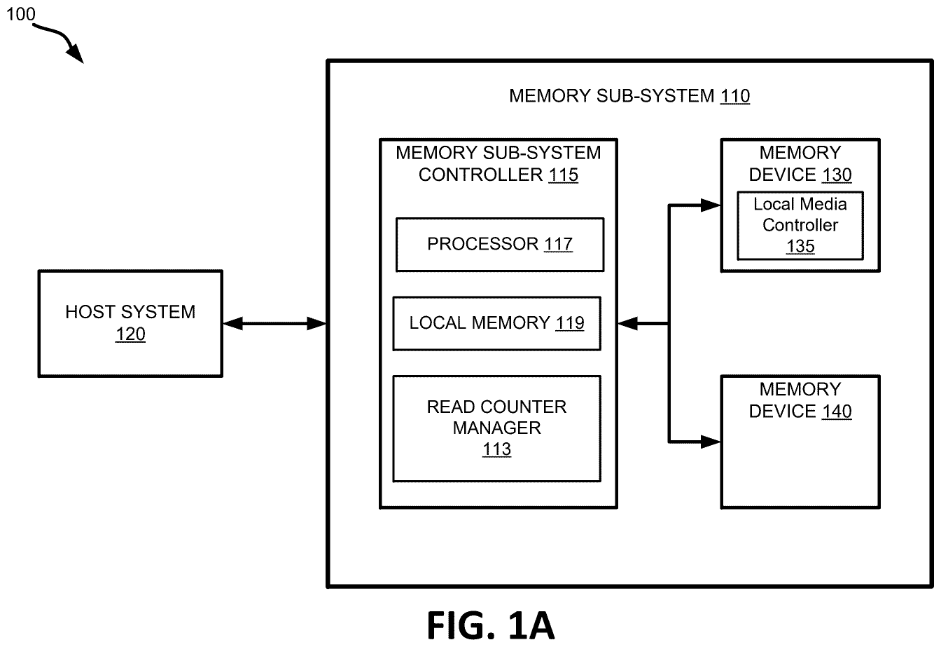

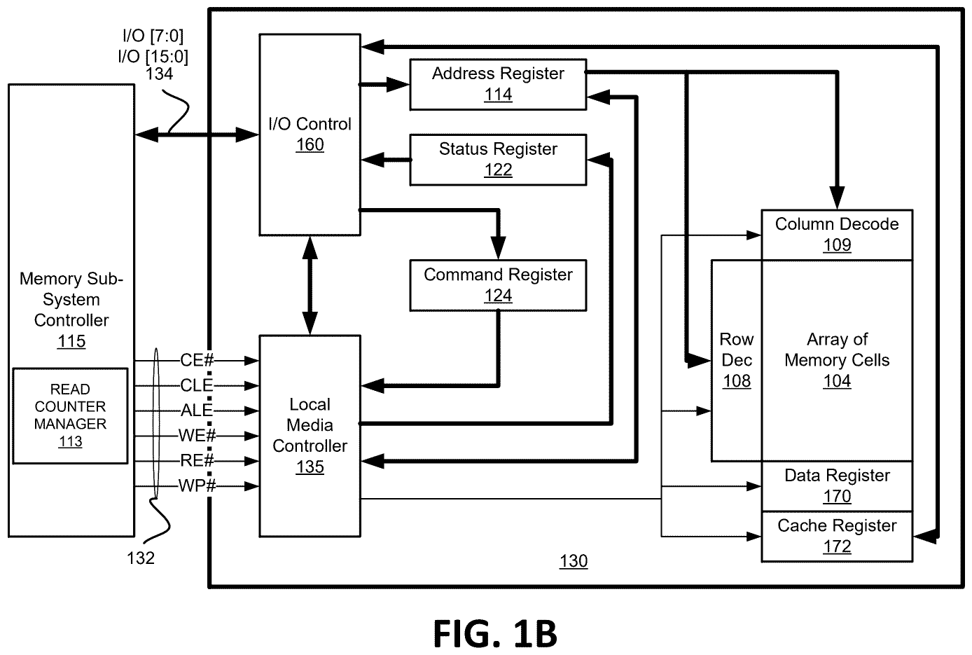

Aspects of the present disclosure are directed to differential wordline scan in a memory sub-system. A memory sub-system can be a storage device, a memory module, or a hybrid of a storage device and memory module. Examples of storage devices and memory modules are described below in conjunction with FIG. 1A. In general, a host system can utilize a memory sub-system that includes one or more memory components. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a negative-and (NAND) memory device. Other examples of non-volatile memory devices are described below in conjunction with FIG. 1A. A non-volatile memory device is a package of one or more dies. Each die can consist of one or more planes. For some types of non-volatile memory devices (e.g., NAND devices), each plane consists of a set of physical blocks. Each block consists of a set of pages. Each page consists of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional grid. Memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form a plane of the memory device in order to allow concurrent operations to take place on each plane. The memory device can include circuitry that performs concurrent memory page accesses of two or more memory planes. For example, the memory device can include a respective access line driver circuit and power circuit for each plane of the memory device to facilitate concurrent access of pages of two or more memory planes, including different page types.

When data is repeatedly written to a memory cell of the memory device for storage, the memory cell can deteriorate. Accordingly, each memory cell of the memory device can handle a finite number of write operations performed before the memory cell is no longer able to reliably store data. Data stored at the memory cells of the memory device can be read from the memory device and transmitted to a host system. When data is read from a memory cell of the memory device, nearby or adjacent memory cells can experience what is known as read disturb. Read disturb is the result of continually reading from one memory cell without intervening erase operations, causing other nearby memory cells to change over time (e.g., become programmed). If too many read operations are performed on a memory cell, data stored at adjacent memory cells of the memory device can become corrupted or incorrectly stored at the memory cell. This can result in a higher error rate of the data stored at the memory cell. This can increase the use of an error detection and correction operation (e.g., an error control operation) for subsequent operations (e.g., read and/or write) performed on the memory cell. The increased use of the error control operation can result in a reduction of the performance of a conventional memory sub-system. In addition, as the error rate for a memory cell or block continues to increase, it may even surpass the error correction capabilities of the memory sub-system, leading to an irreparable loss of the data. Furthermore, as more resources of the memory sub-system are used to perform the error control operation, fewer resources are available to perform other read operations or write operations.

The error rate associated with data stored at the block can increase due to read disturb effects. Therefore, upon a threshold number of read operations being performed on the block, the memory sub-system can perform a data integrity check (e.g., a read disturb scan, also referred to herein as a “scan”) to verify that the data stored at the block does not include any errors. During the data integrity check, one or more reliability statistics are determined for data stored at the block. One example of a reliability statistic is raw bit error rate (RBER). The RBER corresponds to a number of bit errors per unit of time that the data stored at the block experiences.

If the reliability statistic for a block exceeds a threshold value indicating a high error rate associated with data stored at the block due to read disturb, then the data stored at the block can be relocated to a new block of the memory sub-system. Relocating the data stored at old the block to the new block can include writing the data to the new block to refresh the data stored by the memory sub-system. This can be done to negate the effects of read disturb associated with the data and to erase the data at the old block. However, as previously discussed, read disturb can affect memory cells that are adjacent to the memory cell that a read operation is performed on. Therefore, read disturb can induce a non-uniform stress on memory cells of the block if particular memory cells are read from more frequently. For example, memory cells of a block that are adjacent to a memory cell that is frequently read from can have a high error rate, while memory cells that are not adjacent to the memory cell can have a lower error rate due to a reduced impact by read disturb on these memory cells.

Depending on the data access activity of the host system for a particular memory sub-system, the effects of read disturb can be either focused on one or more particular memory pages in a block or distributed more evenly across all the memory pages of the block. If read stress is focused on a single memory page, for example, the block can be considered to be experiencing single page read disturb (SPRD). SPRD can occur in situations where a certain piece of data stored in the memory sub-system is read significantly more often than the rest of the data in the same block. If the read stress is uniformly distributed across multiple memory pages, however, the block can be considered to be experiencing uniform read disturb, which may be referred to as every page read disturb (EPRD). EPRD can occur in situations where each piece of data in a block is read with approximately the same frequency.

As described above, a memory sub-system can perform a data integrity check at the block level using a scan operation (e.g., a data integrity scan). Since scan operations are performed at the block level, the memory sub-system monitors the number of read operations performed on a particular block and performs a scan operation when the read count (i.e., the number of read operations) meets or exceeds a certain threshold value. Depending on the implementation, the memory sub-system can maintain a read counter that tracks the number of read operations performed on the block. The controller cannot distinguish between single page read disturb stress and every page read disturb stress, so it utilizes a threshold value based on single wordline read disturb stress. When memory cells coupled to one wordline in a physical block experience single wordline read disturb stress, the read count to trigger the scan can be significantly lower than the read count of another wordline that only experiences every page read disturb stress. If both wordlines are part of the same physical block and the memory sub-system maintains a common read counter for the physical block, the threshold value will be met significantly faster than the actual number of read operations seen by any of the individual wordlines in the physical block. Thus, although it may be appropriate to scan memory cells coupled to that one wordline, such a scan operation may not be necessary for the remainder of the physical block. Performing unnecessary scan operations in this manner can result in the performance of excessive memory management operations by the memory sub-system. This can result in a decrease of performance of the memory sub-system, as well as an increase in the power consumption of the memory sub-system. System bandwidth and other resources can also be tied up for extended periods of time, preventing the use of those resources for other functionality.

Aspects of the present disclosure address the above and other deficiencies by using a differential wordline scheme for triggering and managing data integrity scans in a memory sub-system. The memory sub-system can implement a set of read counters according to various wordline groups in the memory device (e.g., in the same block, sub-block, or page of a memory device).

One type of wordline groups is referred to as “single page read disturb (SPRD) group.” The memory sub-system can determine a single page read disturb (SPRD) capability of each wordline in a block and group the wordlines with similar (e.g., in a defined range) SPRD capabilities as one SPRD group. To determine a SPRD capability of a wordline (e.g., wordline N), the memory sub-system can perform read operations on the neighboring wordline(s) (e.g., wordline N+1 and/or wordline N−1) and count the number of the read operations until the data is not recoverable via the read error handling. As such, the memory sub-system may configure one or more SPRD groups, and each SPRD group may represent one or more wordlines that are affected more significantly by the read operation performed in the same block.

Another type of wordline groups is referred to as “every page read disturb (EPRD) group.” The memory sub-system can determine a every page read disturb (EPRD) capability of each wordline in a block and group the wordlines with similar (e.g., in a defined range) EPRD capabilities as one EPRD group. To determine a EPRD capability of a wordline (e.g., wordline N), while the number of read operations performed on each wordline in the block is about the same, the memory sub-system can perform read operations on the wordline (e.g., wordline N) and count the number of the read operations until the data is not recoverable via the read error handling. As such, the memory sub-system may configure one or more EPRD groups, and each EPRD group may represent one or more wordlines that tend to be subject to occurrence of unrecoverable error in the same block. In some embodiments, the memory sub-system may maintain a data structure storing information of the set of read counters.

In some embodiments, each block of the memory device has a corresponding set of read counters. Each read counter of the set of read counters can be used to track the number of read operations, performed on the block and associated with the wordline group(s), that can affect the data integrity scan. In some implementations, the memory sub-system may receive a read command directed to one or more wordlines and, based on these wordlines, identify the wordline group(s), i.e., one or more SPRD groups and/or EPRD groups. As each of the wordline groups implements a respective read counter, the read counter may correspond to a scan-trigger criterion and a scan-window criterion, which are used for triggering and managing the data integrity scan. The scan-window criterion (e.g., a scan-window value) defines a frequency (e.g., the maximum number of read operations) for a round of performing a data integrity scan. The scan-trigger criterion (e.g., a scan-trigger value) defines a situation (e.g., after the specific number of read operations) for trigging a data integrity scan during the round of performing a data integrity scan.

In some implementations, the memory sub-system may increment the read counter of each of the identified wordline groups, and when a value of the read counter reaches a scan-trigger value, the memory sub-system may trigger a data integrity scan to determine an error rate for the corresponding wordline(s) of the physical block. In the case of the error rate exceeds a threshold value, the data integrity scan may further involve reading data stored at the corresponding wordline(s) or block and relocating the data to another block. When a value of the read counter reaches a scan-window value, the memory sub-system may reset the read counter such that the data integrity scan can be performed at the frequency defined by the scan-window value for the corresponding wordline(s) of the physical block.

The scan-window value may be a predetermined threshold value that is associated with SPRD or EPRD capability of the corresponding group. In some embodiments, the scan-window value is chosen to correspond to a predetermined amount of aggregate read disturb on the memory cells. In some embodiments, the scan-window value may be a maximum number of read counts allowable without a substantial risk of data loss due to data degradation. In some implementations, the scan-trigger value may be a random value chosen to be smaller than the scan-window value (i.e., in a range from zero to the scan-window value).

Advantages of the present disclosure include reducing the computer resources and data traffic used for data integrity scan by using additional read counters. Separation of SPRD groups and EPRD groups also reduces the frequency of data integrity scan and removes some unnecessary data integrity scan. The different wordlines groups with various frequencies of data integrity scan can be used to target different read disturb mechanisms, including high temperature, low temperature, fast read disturb, slow read disturb, etc.

FIG. 1A illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1A illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, PE cycle counting (e.g., counting PE cycles of memory devices 130, etc.), and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130. In some embodiments, the memory devices 130 include local media controllers 135 that operate in conjunction with memory sub-system controller 115 to execute operations (e.g., programming operations, two-pass programming operations, etc.) on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local controller 132) on the die and a controller (e.g., memory sub-system controller 115) for media management within the same memory device package. An example of a managed memory device is a managed NAND (MNAND) device.

The memory sub-system 110 may include a read counter manager 113 that can implement a set of read counters according to various wordline groups and manage the values of read counters for data integrity scan. The set of read counters may pertain to a specific memory block of one of the memory devices 130 or 140. In some embodiments, each block of memory devices 130 and 140 has a corresponding set of read counters. Each read counter can be used to track the number of read operations, performed on the block and associated with the wordline group(s), that can affect the data integrity scan (e.g., scan frequency). Read counter manager 113 may be responsible for incrementing the read counters, and when a value of the read counter reaches a scan-trigger value, a data integrity scan may be triggered to determine an error rate for the corresponding wordline(s) of the physical block. In the case of the error rate exceeds a threshold value, the data integrity scan may further involve reading data stored at the corresponding wordline(s) or block of memory cells and relocating the data to another block of memory cells. In many embodiments, the data errors may be the result of read disturb stress. Read counter manager 113 may also be responsible for resetting the read counters, and when a value of the read counter reaches a scan-window value, the read counter may be reset such that the data integrity scan can be performed at the frequency defined by the scan-window value for the corresponding wordline(s) of the physical block. In some embodiments, read counter manager 113 may maintain, for example, in local memory 119, a data structure storing related information of the set of read counters. Further details with regards to the read counter manager 113 are described below.

FIG. 1B is a simplified block diagram of a first apparatus, in the form of a memory device 130, in communication with a second apparatus, in the form of a memory sub-system controller 115 of a memory sub-system (e.g., memory sub-system 110 of FIG. 1A), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130), may be a memory controller or other external host device. In one embodiment, memory sub-system controller 115 includes read counter manager 113 configured to perform the read counter incrementing operations described herein including incrementing a read counter based on a scaling factor determined by the read counter manager 113.

Memory device 130 includes an array of memory cells 104 logically arranged in rows and columns. Memory cells of a logical row are typically connected to the same access line (e.g., a wordline) while memory cells of a logical column are typically selectively connected to the same data line (e.g., a bit line). A single access line may be associated with more than one logical row of memory cells and a single data line may be associated with more than one logical column. Memory cells (not shown in FIG. 1B) of at least a portion of array of memory cells 104 are capable of being programmed to one of at least two target data states.

Row decode circuitry 108 and column decode circuitry 109 are provided to decode address signals. Address signals are received and decoded to access the array of memory cells 104. Memory device 130 also includes input/output (I/O) control circuitry 160 to manage input of commands, addresses and data to the memory device 130 as well as output of data and status information from the memory device 130. An address register 114 is in communication with I/O control circuitry 160 and row decode circuitry 108 and column decode circuitry 109 to latch the address signals prior to decoding. A command register 124 is in communication with I/O control circuitry 160 and local media controller 135 to latch incoming commands.

A controller (e.g., the local media controller 135 internal to the memory device 130) controls access to the array of memory cells 104 in response to the commands and generates status information for the external memory sub-system controller 115, i.e., the local media controller 135 is configured to perform access operations (e.g., read operations, programming operations and/or erase operations) on the array of memory cells 104. The local media controller 135 is in communication with row decode circuitry 108 and column decode circuitry 109 to control the row decode circuitry 108 and column decode circuitry 109 in response to the addresses.

The local media controller 135 is also in communication with a cache register 172. Cache register 172 latches data, either incoming or outgoing, as directed by the local media controller 135 to temporarily store data while the array of memory cells 104 is busy writing or reading, respectively, other data. During a program operation (e.g., write operation), data may be passed from the cache register 172 to the data register 170 for transfer to the array of memory cells 104; then new data may be latched in the cache register 172 from the I/O control circuitry 160.

During a read operation, data may be passed from the cache register 172 to the I/O control circuitry 160 for output to the memory sub-system controller 115; then new data may be passed from the data register 170 to the cache register 172. The cache register 172 and/or the data register 170 may form (e.g., may form a portion of) a page buffer of the memory device 130. A page buffer may further include sensing devices (not shown in FIG. 1B) to sense a data state of a memory cell of the array of memory cells 104, e.g., by sensing a state of a data line connected to that memory cell. A status register 122 may be in communication with I/O control circuitry 160 and the local memory controller 135 to latch the status information for output to the memory sub-system controller 115.

Memory device 130 receives control signals at the memory sub-system controller 115 from the local media controller 135 over a control link 132. For example, the control signals can include a chip enable signal CE#, a command latch enable signal CLE, an address latch enable signal ALE, a write enable signal WE#, a read enable signal RE#, and a write protect signal WP#. Additional or alternative control signals (not shown) may be further received over control link 132 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 134 and outputs data to the memory sub-system controller 115 over I/O bus 134.

For example, the commands may be received over input/output (I/O) pins [7:0] of I/O bus 134 at I/O control circuitry 160 and may then be written into command register 124. The addresses may be received over input/output (I/O) pins [7:0] of I/O bus 134 at I/O control circuitry 160 and may then be written into address register 114. The data may be received over input/output (I/O) pins [7:0] for an 8-bit device or input/output (I/O) pins [15:0] for a 16-bit device at I/O control circuitry 160 and then may be written into cache register 172. The data may be subsequently written into data register 170 for programming the array of memory cells 104.

In an embodiment, cache register 172 may be omitted, and the data may be written directly into data register 170. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

It will be appreciated by those skilled in the art that additional circuitry and signals can be provided, and that the memory device 130 of FIG. 1B has been simplified. It should be recognized that the functionality of the various block components described with reference to FIG. 1B may not necessarily be segregated to distinct components or component portions of an integrated circuit device. For example, a single component or component portion of an integrated circuit device could be adapted to perform the functionality of more than one block component of FIG. 1B. Alternatively, one or more components or component portions of an integrated circuit device could be combined to perform the functionality of a single block component of FIG. 1B. Additionally, while specific I/O pins are described in accordance with popular conventions for receipt and output of the various signals, it is noted that other combinations or numbers of I/O pins (or other I/O node structures) may be used in the various embodiments.

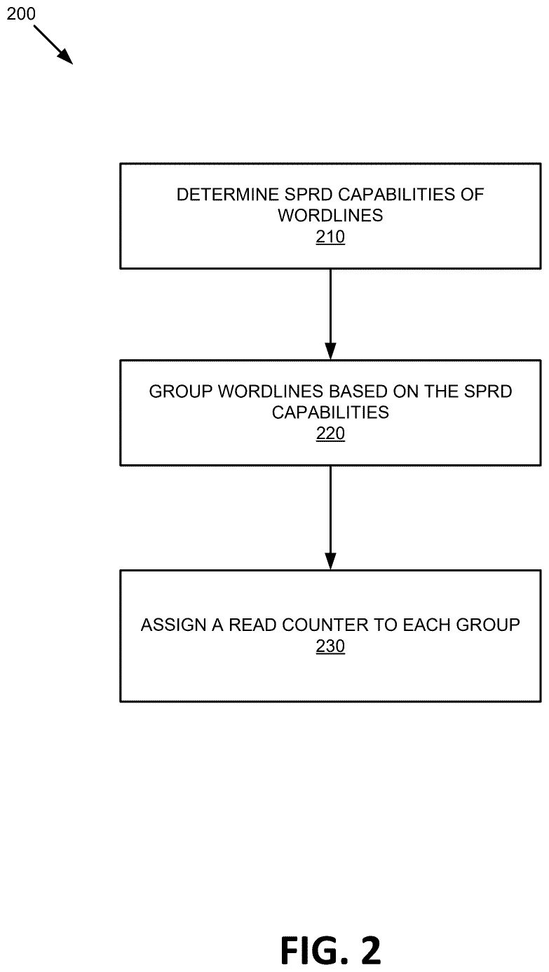

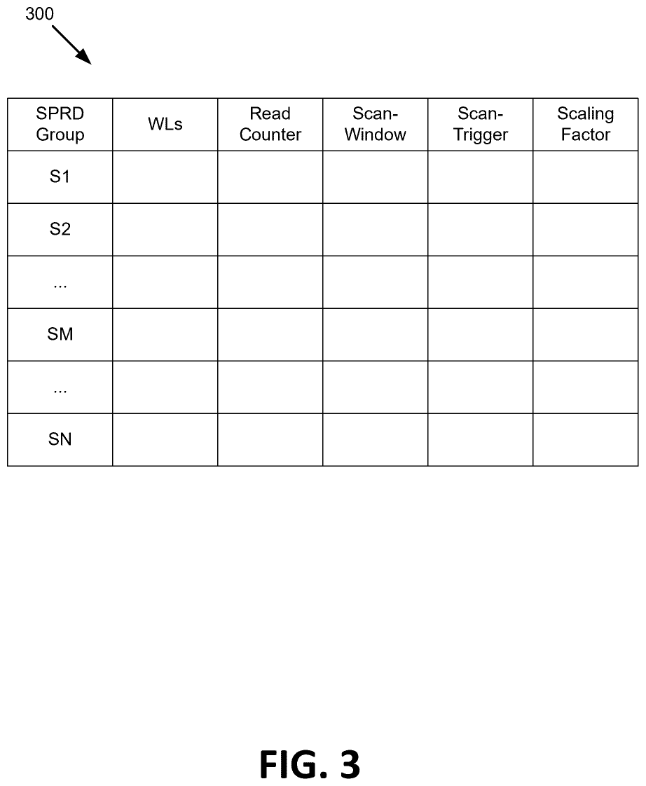

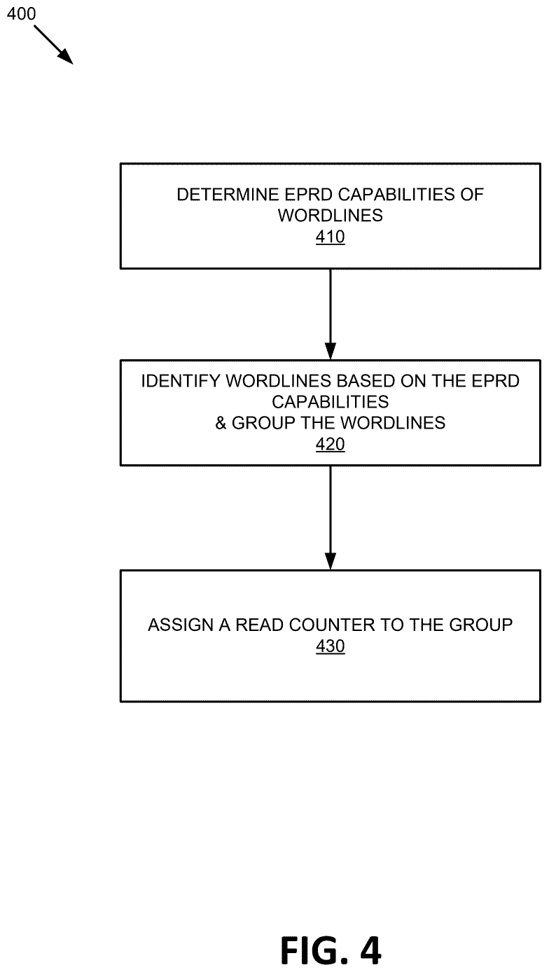

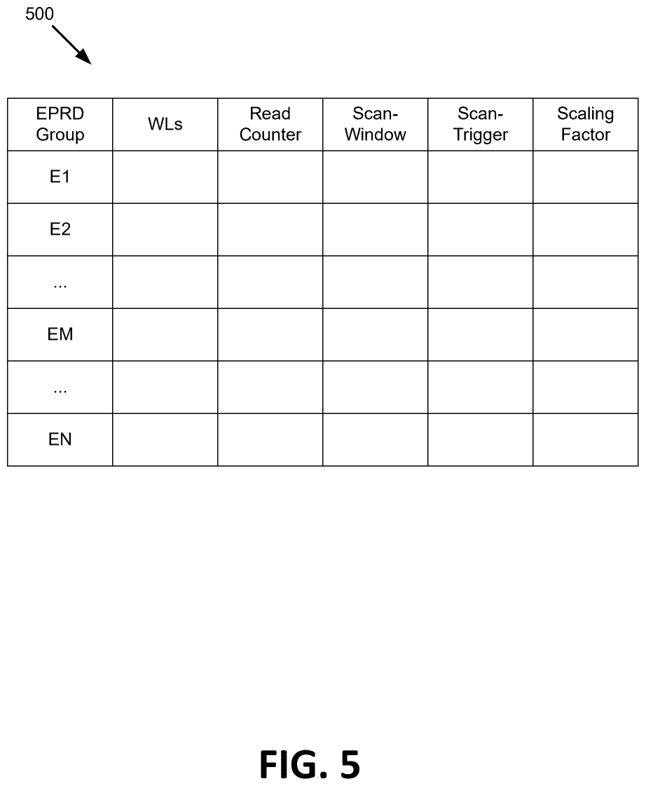

FIG. 2 is a flow diagram of an example method 200 of configuring read counters for SPRD groups for a memory device in accordance with some embodiments of the present disclosure. FIG. 3 is an example read counter data structure 300 for an example method 200 of configuring read counters for SPRD groups for a memory device in accordance with some embodiments of the present disclosure. FIG. 4 is a flow diagram of an example method 400 of configuring read counters for EPRD groups for a memory device in accordance with some embodiments of the present disclosure. FIG. 5 is an example read counter data structure 500 for an example method 400 of configuring read counters for EPRD groups for a memory device in accordance with some embodiments of the present disclosure.

Referring to FIG. 2, the method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the read counter manager 113 of FIGS. 1A and 1B. In some embodiments, the method 200 is performed by the host system 120 of FIG. 1A. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 210, the processing device may perform a characterization test on a block to determine a read disturb capability for each wordline in the block. The read disturb capability refers to the number of read operations that can be performed prior to the occurrence of unrecoverable error. In some implementations, the processing device may perform memory access operations on each wordline and count the number of the memory access operations until the data is not recoverable via the read error handling.

In some implementations, the processing device may determine read disturb capabilities of the wordlines based on the reliability statistics, such as error rates. In some implementations, the read disturb capability may be calculated according to a relationship with the error rates. In some implementations, the processing device may compare the error rate for each wordline to a threshold error rate for the block to normalize the results, and the remaining percentage of the normalized result may represent the read disturb capability. For example, the processing device may determine a percentage of the error rate of the wordline (e.g., 20) to the threshold error rate (e.g., 200), and calculate the remaining percentage (e.g., 1−20/200 32 90%) as the read disturb capability of the wordline.

At operation 210, the processing device determines single page read disturb (SPRD) capabilities of each wordline in a block. To determine a SPRD capability of a wordline (e.g., wordline N), the processing device may perform read operations on the neighboring wordline(s) (e.g., wordline N+1 and/or wordline N−1) and count the number of the read operations until the data is not recoverable via the read error handling.

At operation 220, the processing device groups wordlines in the block based on the SPRD capabilities. In some implementations, the processing device may compare the SPRD capability for each wordline to one or more reference values to group the wordlines. For example, the processing device may place wordlines with the SPRD capabilities of the first range (e.g., X1 to X2) in a first SPRD group (e.g., with group identifier S1), and place wordlines with the SPRD capabilities of the second range (e.g., X2 to X3) in a second SPRD group (e.g., with group identifier S2), etc. As such, the processing device may configure one or more SPRD groups, and each SPRD group may represent one or more wordlines that are affected more significantly by the read operation performed in the same block (“neighboring wordlines”).

In some implementations, the processing device may maintain a data structure to store the read counter information. An example of such data structure is illustrated with respect to FIG. 3. FIG. 3 is a block diagram illustrating a data structure 300 for storing information of SPRD groups in accordance with some embodiments of the present disclosure. Referring to FIG. 3, the data structure 300 can be stored, for example, in local memory 119, and may include a set of entries that corresponds to a memory component (e.g., a block), and each entry specifies a SPRD group identifier and the corresponding wordlines.

Referring back to FIG. 2, at operation 230, the processing device assigns a read counter to each SPRD group. For example, the processing device may assign a first read counter to a first SPRD group, assign a second read counter to a second SPRD group, etc.

In some implementations, the processing device may assign a shared read counter to one or more SPRD groups to reduce the number of read counters. In such cases, the processing device may determine a scaling factor based on a ratio of the SPRD capability associated with one SPRD group to the SPRD capability associated with another SPRD group. The scaling factor is a factor by which a read counter will be incremented in order to accurately reflect an amount of stress caused by read operations on memory cells. In one embodiment, read counter manager 113 determines a first average SPRD capability for all of the wordlines of the first SPRD group and a second average SPRD capability for all of the wordlines of the second SPRD group, and use the ratio of the second average SPRD capability to the first average SPRD capability as the scaling factor for the second SPRD group with respect to the first SPRD group. In another embodiment, read counter manager 113 determines a first maximum SPRD capability for all of the wordlines of the first SPRD group and a second maximum SPRD capability for all of the wordlines of the second SPRD group, and use the ratio of the second maximum SPRD capability to the first maximum SPRD capability as the scaling factor for the second SPRD group with respect to the first SPRD group. For example, the processing device may assign a first read counter (without a scaling factor or with a scaling factor “1”) to the first SPRD group, and assign the first read counter with a scaling factor described above to the second SPRD group. In one embodiment, read counter manager 113 can store an indication of the scaling factor in data structure 300, as illustrated in FIG. 3.

In some implementations, the processing device may determine a scan-window value for each read counter. The scan-window value defines a frequency (e.g., the maximum number of read operations) for a round of performing a data integrity scan. In some implementations, the scan-window value of the read counter may be proportional to the SPRD capability associated with the corresponding SPRD group. In one embodiment, read counter manager 113 determines a first average SPRD capability for all of the wordlines of the first SPRD group and a second average SPRD capability for all of the wordlines of the second SPRD group, and determine the scan-window value of the first read counter as being proportional to the first average SPRD capability and the scan-window value of the second read counter as being proportional to the second average SPRD capability. In another embodiment, read counter manager 113 determines a first maximum SPRD capability for all of the wordlines of the first SPRD group and a second maximum SPRD capability for all of the wordlines of the second SPRD group, and determine the scan-window value of the first read counter as being proportional to the first maximum SPRD capability and the scan-window value of the second read counter as being proportional to the second maximum SPRD capability. In one embodiment, read counter manager 113 can store an indication of the scan-window value in data structure 300, as illustrated in FIG. 3.

In some implementations, the processing device may determine a scan-trigger value for each read counter. The scan-trigger value defines a situation (e.g., after the specific number of read operations) for trigging a data integrity scan during the round of performing a data integrity scan. In some implementations, the scan-trigger value of the read counter may be a random value between 0 and the scan-window value of the read counter. In one embodiment, read counter manager 113 can store an indication of the scan-trigger value in data structure 300, as illustrated in FIG. 3.

As such, as illustrated in FIG. 3, the data structure 300 may include a set of read counters corresponding to a memory component, such as a block or other granularity of memory cells. Each entry can correspond to one read counter and may include an identifier of the SPRD group, an identifier of the corresponding wordlines, a current value of the read counter for the group, a defined scan-window value, a defined scan-trigger value, and if applicable, the determined scaling factor.

Referring to FIG. 4, the method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the read counter manager 113 of FIGS. 1A and 1B. In some embodiments, the method 400 is performed by the host system 120 of FIG. 1A. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing device may perform a characterization test on a block to determine a read disturb capability for each wordline in the block. The read disturb capability refers to the number of read operations that can be performed prior to the occurrence of unrecoverable error. In some implementations, the processing device may perform memory access operations on each wordline and count the number of the memory access operations until the data is not recoverable via the read error handling.

In some implementations, the processing device may determine read disturb capabilities of the wordlines based on the reliability statistics, such as error rates. In some implementations, the read disturb capability may be calculated according to a relationship with the error rates. In some implementations, the processing device may compare the error rate for each wordline to a threshold error rate for the block to normalize the results, and the remaining percentage of the normalized result may represent the read disturb capability. For example, the processing device may determine a percentage of the error rate of the wordline (e.g., 20) to the threshold error rate (e.g., 200), and calculate the remaining percentage (e.g., 1−20/200=90%) as the read disturb capability of the wordline.

At operation 410, the processing device may determine every page read disturb (EPRD) capabilities of each wordline in a block. To determine a EPRD capability of a wordline (e.g., wordline N), while the number of read operations performed on each wordline in the block is about the same, the processing device may perform read operations on the wordline (e.g., wordline N) and count the number of the read operations until the data is not recoverable via the read error handling.

At operation 420, the processing device identifies wordlines in the block based on the EPRD capabilities. In some implementations, the processing device may compare the EPRD capability for each wordline to one or more reference values to identify the wordlines. For example, the processing device may identify wordlines with the EPRD capabilities below a threshold value (e.g., Y1). In some implementations, the processing device may place the identified wordlines into one or more groups (“EPRD groups”). For example, the processing device may place wordlines with the EPRD capabilities of the first range (e.g., Y1 to Y2) in a first EPRD group (e.g., with group identifier E1), and place wordlines with the EPRD capabilities of the second range (e.g., Y2 to Y3) in a second EPRD group (e.g., with group identifier E2), etc. As such, the processing device may configure one or more EPRD groups, and each EPRD group may represent one or more wordlines that tend to be subject to occurrence of unrecoverable error in the same block (“mandatory wordlines”).

In some implementations, the processing device may maintain a data structure to store the read counter information. An example of such data structure is illustrated with respect to FIG. 5. FIG. 5 is a block diagram illustrating a data structure 300 for storing information of EPRD groups in accordance with some embodiments of the present disclosure. Referring to FIG. 5, the data structure 500 can be stored, for example, in local memory 119, and may include a set of entries that corresponds to a memory component (e.g., a block), and each entry specifies a EPRD group identifier and the corresponding wordlines.

Referring back to FIG. 4, at operation 430, the processing device assigns a read counter to each EPRD group. For example, the processing device may assign a first read counter to a first EPRD group, assign a second read counter to a second EPRD group, etc.

In some implementations, the processing device may assign a shared read counter to one or more EPRD groups to reduce the number of read counters. In such cases, the processing device may determine a scaling factor based on a ratio of the EPRD capability associated with one EPRD group to the EPRD capability associated with another EPRD group. The scaling factor is a factor by which a read counter will be incremented in order to accurately reflect an amount of stress caused by read operations on memory cells. In one embodiment, read counter manager 113 determines a first average EPRD capability for all of the wordlines of the first EPRD group and a second average EPRD capability for all of the wordlines of the second EPRD group, and use the ratio of the second average EPRD capability to the first average EPRD capability as the scaling factor for the second EPRD group with respect to the first EPRD group. In another embodiment, read counter manager 113 determines a first maximum EPRD capability for all of the wordlines of the first EPRD group and a second maximum EPRD capability for all of the wordlines of the second EPRD group, and use the ratio of the second maximum EPRD capability to the first maximum EPRD capability as the scaling factor for the second EPRD group with respect to the first EPRD group. For example, the processing device may assign a first read counter (without a scaling factor or with a scaling factor “1”) to the first EPRD group, and assign the first read counter with a scaling factor described above to the second EPRD group. In one embodiment, read counter manager 113 can store an indication of the scaling factor in data structure 500, as illustrated in FIG. 5.

In some implementations, the processing device may determine a scan-window criterion for each read counter. The scan-window criterion defines a frequency (e.g., the maximum number of read operations) for a round of performing a data integrity scan. In some implementations, the processing device may determine a scan-window value as a scan-window criterion for each read counter. In some implementations, the scan-window value of the read counter may be proportional to the EPRD capability associated with the corresponding EPRD group. In one embodiment, read counter manager 113 determines a first average EPRD capability for all of the wordlines of the first EPRD group and a second average EPRD capability for all of the wordlines of the second EPRD group, and determine the scan-window value of the first read counter as being proportional to the first average EPRD capability and the scan-window value of the second read counter as being proportional to the second average EPRD capability. In another embodiment, read counter manager 113 determines a first maximum EPRD capability for all of the wordlines of the first EPRD group and a second maximum EPRD capability for all of the wordlines of the second EPRD group, and determine the scan-window value of the first read counter as being proportional to the first maximum EPRD capability and the scan-window value of the second read counter as being proportional to the second maximum EPRD capability. In one embodiment, read counter manager 113 can store an indication of the scan-window value in data structure 500, as illustrated in FIG. 5.

In some implementations, the processing device may determine a scan-trigger criterion for each read counter. The scan-trigger criterion defines a situation (e.g., after the specific number of read operations) for trigging a data integrity scan during the round of performing a data integrity scan. In some implementations, the processing device may determine a scan-trigger value as a scan-trigger criterion for each read counter. In some implementations, the scan-trigger value of the read counter may be a random value between 0 and the scan-window value of the read counter. In one embodiment, read counter manager 113 can store an indication of the scan-trigger value in data structure 500, as illustrated in FIG. 5.

As such, as illustrated in FIG. 5, the data structure 500 may include a set of read counters corresponding to a memory component, such as a block or other granularity of memory cells. Each entry can correspond to one read counter and may include an identifier of the EPRD group, an identifier of the corresponding wordlines, a current value of the read counter for the group, a defined scan-window value, a defined scan-trigger value, and if applicable, the determined scaling factor.

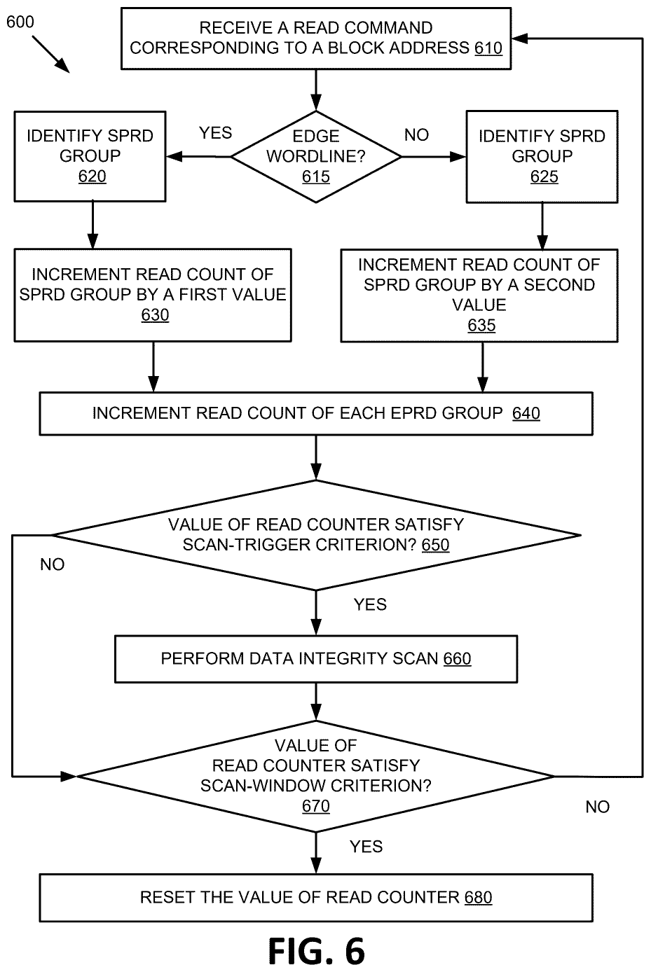

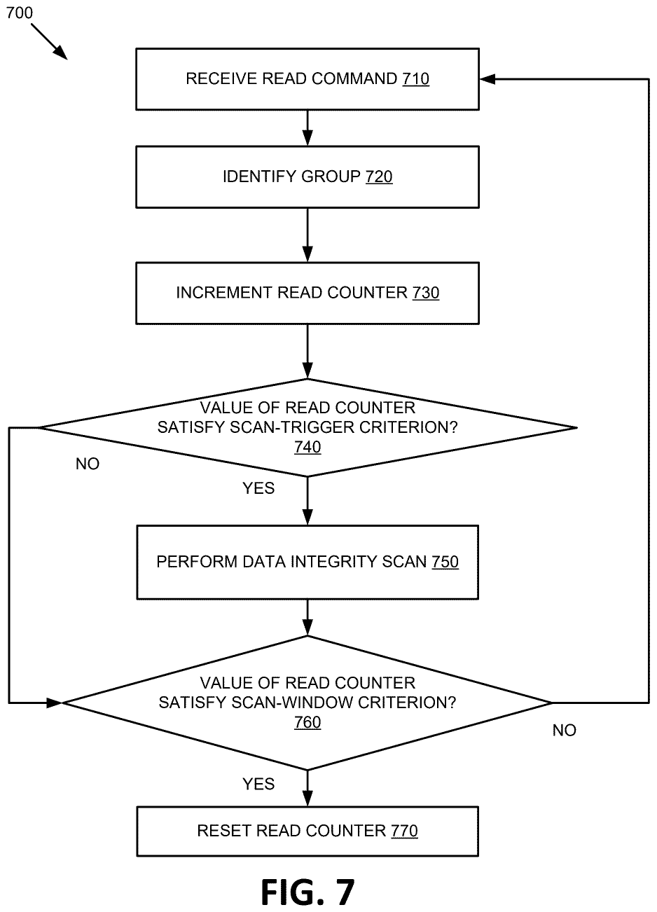

FIGS. 6-7 are block diagrams of example methods 700 and 800 of managing a read counter for a memory device in accordance with some embodiments of the present disclosure. The methods 700 and 800 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the methods 700 and 800 are performed by the read counter manager 113 of FIGS. 1A and 1B. In some embodiments, the methods 700 and 800 are performed by the host system 120 of FIG. 1A. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible. Referring to FIG. 6, at operation 610, the processing logic may receive a read command. The read command may correspond to a set of memory cells located at an address of the memory device. In some embodiments, the read command specifies the physical block address at which the set of memory cells are located. In some embodiments, the read command may be a read operation to be performed on a block of memory cells (e.g., a memory block, a block, etc.). In some embodiments, the read command may be a read operation to be performed on memory cells coupled to one or more specific wordlines.

At operation 615, the processing logic may determine whether the read command is directed to a wordline at the edge of the memory component (e.g., block) of the memory device (“edge wordline”). In some embodiments, the read command may correspond to a set of memory cells located at an address of the memory device, and the processing logic may determine whether the set of memory cells falls in the edge wordline.

At operation 620, responsive to determining that the read command is directed to an edge wordline, the processing logic may identify the neighboring wordline of the edge wordline and identify a SPRD group of the neighboring wordline. At operation 630, the processing logic may increment the read counter of the SPRD group by a first default value (e.g., 1).

At operation 625, responsive to determining that the read command is not directed to an edge wordline, the processing logic may identify the neighboring wordlines of the set of memory cells and identify one or more SPRD groups of the neighboring wordlines. At operation 635, the processing logic may increment the read counter of each SPRD group by a second default value (e.g., 0.5). In some implementations, the second default value is smaller than the first default value.

At operation 640, the processing logic may increment the read counter of each EPRD group by a third default value (e.g., 1). In some implementations, the third default value is equal to the first default value.

In some embodiments, the processing logic increments the read counter associated with one or more groups (e.g., SPRD group and/or EPRD group) of a block of a memory device. The read counter may count read operations executed with respect to the group and/or the wordline (e.g., at a physical address) of the memory device. The read counter may be incremented based on the scaling factor described above. In some implementations, the value of read counter may reflect the amount of read disturb stress experienced by memory cells of the block.

At operation 650, processing logic determines whether a value reflected by the read counter satisfies a threshold criterion to trigger the performance of a data integrity scan (“scan-trigger criterion”). The scan-trigger criterion may be a predetermined threshold value (“scan-trigger value”). In some embodiments, the scan-trigger value may be a random value selected within a range that is below a scan-window value described below.

At operation 660, responsive to processing logic determining that the value reflected by the read counter satisfies the scan-trigger criterion, the processing logic triggers the performance of a data integrity scan. The data integrity scan may be a scan to verify that data stored in the memory cells has not degraded past a threshold degradation and/or to determine data that needs to be erased and re-written to the memory cells because of errors introduced (e.g., due to read disturb). In some embodiments, the data integrity scan is a read disturb scan to detect read disturb in the memory cells. A read disturb scan may sample data stored in memory cells at every wordline of a block. The read disturb scan may measure a bit error rate and compare the error rate with a reliability threshold. If the bit error rate does not meet the reliability threshold, a data refresh (e.g., a data erase and re-write) may be triggered.

In some implementations, the processing device may perform a data integrity scan to determine one or more reliability statistics, such as the error rate (e.g., RBER), associated with each wordline in a block. In some implementations, during the scan, the processing device may read a raw code word (i.e., a series of a fixed number of bits) from each wordline, apply the code word to an ECC decoder to generate a decoded code word, and compare the decoded code word to the raw code word. In some implementations, the processing device may count a number of flipped bits between the decoded code word and the raw code word, and use a ratio of the number of flipped bits to the total number of bits in the code word to represent the RBER. In some implementations, the processing device may repeat this process for additional code words until each wordline in the group has been scanned. As such, the processing device may determine the error rate (e.g., RBER) for each wordline in the group. In some implementations, the processing device may compare the error rates of each wordline to one another and determine the highest error rates. For example, the processing device may identify wordlines having an error rate that exceeds an average of all wordline error rates by a certain threshold value as wordlines that make up a victim region.

In some implementations, in the case of the error rate exceeds a threshold value, the data integrity scan may further involve folding data by reading data stored at the corresponding wordline(s) or block and relocating the data to another block. In one implementation, only the failing wordline(s) (i.e., the wordlines with the error rate exceeding the threshold value) are folded, while the remaining wordline(s) in the block are assumed to be useful and not folded. In one implementation, when all wordlines in a wordline group (e.g., a EPRD group) are folded, the remaining wordlines in the block may be folded as well.

At operation 670, after the performance of data integrity scan or responsive to that the value reflected by the read counter does not satisfy the scan-trigger criterion, the processing logic may determine whether the value reflected by the read counter satisfies a threshold criterion that defines maximum number of read operation to implement a data integrity scan (“scan-window criterion”). The scan-window criterion may be a predetermined threshold value (“scan-window value”) that is associated with SPRD or EPRD capability of the corresponding group. In some embodiments, the scan-window value is chosen to correspond with a predetermined amount of aggregate read disturb on the memory cells. The scan-window value may be a maximum number of read counts allowable without a substantial risk of data loss due to data degradation. In some implementations, the scan-trigger value may be a random value chosen to be smaller than the scan-window value (i.e., in a range from zero to the scan-window value).

At operation 680, responsive to determining that the value reflected by the read counter satisfies the scan-window criterion, the processing logic may reset the value reflected by the read counter (e.g., reset to “0”). In some embodiments, responsive to that the value reflected by the read counter does not satisfy the scan-window criterion, the processing logic may proceed to receive another read command at operation 610.

Referring to FIG. 7, at operation 710, the processing logic may receive a read command corresponding to a set of memory cells. In some implementations, the processing logic may receive a read command with respect to a set of memory cells of the plurality of memory cells of the memory device. In some implementations, operation 710 may be similar to or same as the operation 610.

At operation 720, processing logic may identify a SPRD and/or EPRD group that is associated with the set of memory cells. In some implementations, the processing logic may identify a first group, of a plurality of groups, associated with the set of memory cells, wherein each of the plurality of groups comprises one or more wordlines. In some implementations, each of the plurality of groups implements a respective read counter and a corresponding scan-trigger criterion. In some implementations, each of the plurality of groups implements the respective read counter and a corresponding scan-window criterion. In some implementations, the corresponding scan-trigger criterion is associated with the corresponding scan-window criterion (e.g., a scan-trigger value is chosen based on a scan-window value). In some implementations, the plurality of groups comprises one or more single page read disturb (SPRD) groups, and one or more every page read disturb (EPRD) groups. In some implementations, operation 720 may be similar to or same as the operations 620 and/or 625.

At operation 730, the processing logic may increment the read counter of the identified SPRD and/or EPRD group. In some implementations, operation 730 may be similar to or same as the operations 630, 635, and/or 640. In some implementations, the processing logic may increment a first read counter of the first group.

In some implementations, the first group comprises a single page read disturb (SPRD) group, and the processing logic may determine whether the set of memory cells is associated with an edge wordline. In some implementations, the processing logic may determine that the set of memory cells is associated with the edge wordline, and increment the first read counter by a first preset value. In some implementations, the processing logic may determine that the set of memory cells is not associated with an edge wordline, increment the first read counter of the first group by a second preset value, determine a second group, of a plurality of neighboring groups, associated with the set of memory cells, and increment a second read counter of the second group by the second preset value.

In some implementations, the first group comprises a every page read disturb (EPRD) group, and the first read counter is incremented by a third preset value.

At operation 740, the processing logic determines that a value of the read counter satisfies a scan-trigger criterion. In some implementations, the scan-trigger criterion may a threshold value that is randomly chosen in a range from zero to a scan-window value. In some implementations, operation 740 may be similar to or same as the operation 650.

At operation 750, the processing logic performs a data integrity scan with respect to the set of memory cells responsive to determining that the value of the read counter satisfies the scan-trigger criterion in block 740. The data integrity scan may be a scan of the set of memory cells to determine an error rate and/or to determine data integrity. The data integrity scan may determine whether data stored in the memory cells has degraded and needs a refresh. In some implementations, operation 750 may be similar to or same as the operation 660.

At operation 760, the processing logic determines whether the value of the read counter satisfies a scan-window criterion. In some implementations, the scan-window criterion may be a predetermined threshold value (“scan-window value”) that is associated with SPRD or EPRD capability of the corresponding group. In some implementations, after the performance of data integrity scan or responsive to determining that the value of the read counter does not satisfy the scan-trigger criterion, the processing logic may determine whether the value of the read counter satisfies a scan-window criterion. In some implementations, operation 760 may be similar to or same as the operation 670.

At operation 770, processing logic reset the read counter responsive to determining that the value of the read counter satisfies the scan-window criterion in block 760. In some implementations, operation 770 may be similar to or same as the operation 680.

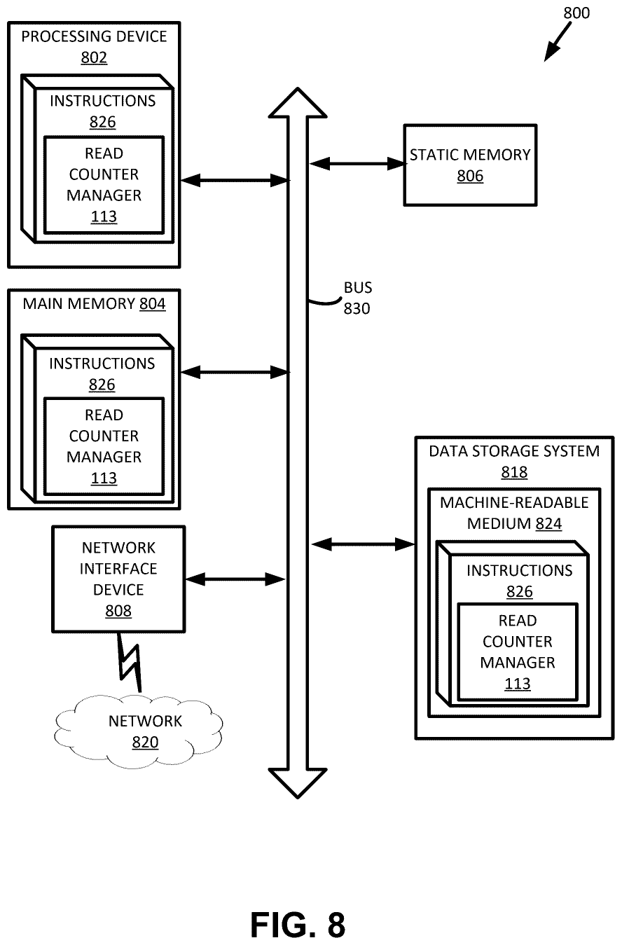

FIG. 8 illustrates an example machine of a computer system 800 within which a set of instructions, for causing the machine to perform any one or more of the methodologies discussed herein, can be executed. In some embodiments, the computer system 800 can correspond to a host system (e.g., the host system 120 of FIG. 1A) that includes, is coupled to, or utilizes a memory sub-system (e.g., the memory sub-system 110 of FIG. 1A) or can be used to perform the operations of a controller (e.g., to execute an operating system to perform operations corresponding to the read counter manager 113 of FIGS. 1A and 1B). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a data storage system 818, which communicate with each other via a bus 830.

Processing device 802 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 can also be one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein. The computer system 800 can further include a network interface device 808 to communicate over the network 820.

The data storage system 818 can include a machine-readable storage medium 824 (also known as a computer-readable medium or a non-transitory computer-readable storage medium) on which is stored one or more sets of instructions 826 or software embodying any one or more of the methodologies or functions described herein. The instructions 826 can also reside, completely or at least partially, within the main memory 804 and/or within the processing device 802 during execution thereof by the computer system 800, the main memory 804 and the processing device 802 also constituting machine-readable storage media. The machine-readable storage medium 824, data storage system 818, and/or main memory 804 can correspond to the memory sub-system 110 of FIG. 1A.

In one embodiment, the instructions 826 include instructions to implement functionality corresponding to the read counter manager 113 of FIG. 1A. While the machine-readable storage medium 824 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device comprising a plurality of memory cells; and
a processing device, operatively coupled with the memory device, to perform operations comprising:
receiving a read command with respect to a set of memory cells of the plurality of memory cells of the memory device;
identifying a first group, of a plurality of groups, associated with the set of memory cells, wherein each group of the plurality of groups comprises one or more wordlines of the memory device, wherein each group of the plurality of groups is formed based on a read disturb capability of each wordline in the group, wherein each group of the plurality of groups has a respective read counter of a plurality of read counters, and wherein each read counter of the plurality of read counters has a corresponding scan-trigger criterion;
incrementing a first read counter, of the plurality of read counters, associated with the first group;
determining whether a first value of the first read counter satisfies a first scan-trigger criterion associated with the first read counter; and
responsive to determining that the first value of the first read counter satisfies the first scan-trigger criterion associated with the first read counter, performing a data integrity scan with respect to the one or more wordlines of the first group.

2. The system of claim 1, wherein the plurality of groups comprises one or more single page read disturb (SPRD) groups, and one or more every page read disturb (EPRD) groups, and wherein the read disturb capability comprises a SPRD capability or an EPRD capability.

3. The system of claim 1, wherein the respective read counter of each of the plurality of groups has a corresponding scan-window criterion, and wherein the corresponding scan-trigger criterion is associated with the corresponding scan-window criterion.

4. The system of claim 3, wherein the operations further comprise:
determining whether the first value of the first read counter satisfies a first scan-window criterion that corresponds to the first read counter; and
responsive to determining that the first value satisfies the first scan-window criterion, resetting the first value of the first read counter.

5. The system of claim 1, wherein the first group comprises a single page read disturb (SPRD) group, and wherein the operations further comprise:
determining whether the set of memory cells is associated with an edge wordline.

6. The system of claim 5, wherein the operations further comprise:
determining that the set of memory cells is associated with the edge wordline, and incrementing the first read counter by a first preset value.

7. The system of claim 5, wherein the operations further comprise:
determining that the set of memory cells is not associated with an edge wordline;
incrementing the first read counter of the first group by a second preset value;
determining a second group, of a plurality of neighboring groups, associated with the set of memory cells; and
incrementing a second read counter of the second group by the second preset value.

8. The system of claim 1, wherein the first group comprises an every page read disturb (EPRD) group, and wherein the first read counter is incremented by a third preset value.

9. A method comprising:
receiving, by a processing device, a read command with respect to a set of memory cells of a plurality of memory cells of a memory device;
identifying a first group, of a plurality of groups, associated with the set of memory cells, wherein each group of the plurality of groups comprises one or more wordlines of the memory device, wherein each group of the plurality of groups is formed based on a read disturb capability of each wordline in the group, wherein each group of the plurality of groups has a respective read counter of a plurality of read counters, and wherein each read counter of the plurality of read counters has a corresponding scan-trigger criterion;
incrementing a first read counter, of the plurality of read counters, associated with the first group;
determining whether a first value of the first read counter satisfies a first scan-trigger criterion associated with the first read counter; and
responsive to determining that the first value of the first read counter satisfies the first scan-trigger criterion associated with the first read counter, performing a data integrity scan with respect to the one or more wordlines of the first group.

10. The method of claim 9, wherein the plurality of groups comprises one or more single page read disturb (SPRD) groups, and one or more every page read disturb (EPRD) groups, and wherein the read disturb capability comprises a SPRD capability or an EPRD capability.

11. The method of claim 9, wherein the respective read counter of each of the plurality of groups has a corresponding scan-window criterion, and wherein the corresponding scan-trigger criterion is associated with the corresponding scan-window criterion.

12. The method of claim 11, further comprising:
determining whether the first value of the first read counter satisfies a first scan-window criterion that corresponds to the first read counter; and
responsive to determining that the first value satisfies the first scan-window criterion, resetting the first value of the first read counter.

13. The method of claim 9, wherein the first group comprises a single page read disturb (SPRD) group, and the method further comprising:
determining whether the set of memory cells is associated with an edge wordline.

14. The method of claim 13, further comprising:
determining that the set of memory cells is associated with the edge wordline, and incrementing the first read counter by a first preset value.

15. The method of claim 13, further comprising:
determining that the set of memory cells is not associated with an edge wordline;
incrementing the first read counter of the first group by a second preset value;
determining a second group, of a plurality of neighboring groups, associated with the set of memory cells; and
incrementing a second read counter of the second group by the second preset value.

16. The method of claim 9, wherein the first group comprises an every page read disturb (EPRD) group, and wherein the first read counter is incremented by a third preset value.

17. A non-transitory computer-readable storage medium comprising instructions that, when executed by a processing device, cause the processing device to perform operations comprising:
receiving a read command with respect to a set of memory cells of a plurality of memory cells of a memory device;
identifying a first group, of a plurality of groups, associated with the set of memory cells, wherein each group of the plurality of groups comprises one or more wordlines of the memory device, wherein each group of the plurality of groups is formed based on a read disturb capability of each wordline in the group, wherein each group of the plurality of groups has a respective read counter of a plurality of read counters, and wherein each read counter of the plurality of read counters has a corresponding scan-trigger criterion;
incrementing a first read counter, of the plurality of read counters, associated with the first group;
determining whether a first value of the first read counter satisfies a first scan-trigger criterion associated with the first read counter; and
responsive to determining that the first value of the first read counter satisfies the first scan-trigger criterion associated with the first read counter, performing a data integrity scan with respect to the one or more wordlines of the first group.

18. The non-transitory computer-readable storage medium of claim 17, wherein the plurality of groups comprises one or more single page read disturb (SPRD) groups, and one or more every page read disturb (EPRD) groups, and wherein the read disturb capability comprises a SPRD capability or an EPRD capability.

19. The non-transitory computer-readable storage medium of claim 17, wherein the respective read counter of each of the plurality of groups has a corresponding scan-window criterion, and wherein the corresponding scan-trigger criterion is associated with the corresponding scan-window criterion.

20. The non-transitory computer-readable storage medium of claim 19, wherein the operations further comprise:
determining whether the first value of the first read counter satisfies a first scan-window criterion that corresponds to the first read counter; and
responsive to determining that the first value satisfies the first scan-window criterion, resetting the first value of the first read counter.
